(19) United States
(12) Patent Application Publication
(10) Pub. No.: US 2022/0402771 A1
(43) Pub. Date: Dec. 22, 2022

(54) Ceramic

(71) Applicant: UNIVERSITY OF LEEDS, Leeds (GB)

(72) Inventors: Steven John MILNE, Leeds (GB); Andrew Paul BROWN, Leeds (GB); Thomas Anthony BROWN, Leeds (GB)

(73) Assignee: UNIVERSITY OF LEEDS, Leeds (GB)

(21) Appl. No.: 17/773,511

(22) PCT Filed: Oct. 29, 2020
(86) PCT No.: PCT/GB2020/052731

§ 371 Date: Apr. 29, 2022

(30) Foreign Application Priority Data
Oct. 31, 2019 (GB) 1915806.2

(51) Int. Cl. C01G 33/00; H01G 4/12

(52) U.S. Cl. CPC C01G 33/006; H01G 4/1263; C01P 2002/52; C01P 2002/76; C01P 2006/40; C01P 2002/72; C01P 2004/03; C01P 2004/04; C01P 2002/85

(57) ABSTRACT

The present invention relates to a ceramic, to a process for preparing the ceramic and to the use of the ceramic as a dielectric in a capacitor.

The present invention relates to a ceramic, to a process for preparing the ceramic and to the use of the ceramic as a dielectric in a capacitor.

Commercially available Class II, high volumetric efficiency X7R-9R ceramic capacitors based on ferroelectric BaTiO₃ have an operating range of −55° C. to 125-175° C. These upper temperature limits are insufficient for many emerging electronics applications related to renewable and low-carbon energy technologies. High voltage power electronics are required in renewable energy generation and grid distribution and rely on passive components that can operate alongside wide band gap semiconductors at temperatures 250° C. There are other applications where Class II capacitors must maintain stable performance to even higher temperatures such as ≥300° C. An example is in distributed engine control circuitry being developed for aerospace applications and for deep-well drill-bit feedback systems in geothermal energy exploration.

Suitable next-generation dielectrics must retain the industry standard lower operating temperature of −55° C. and upper limit of 250-300° C., whilst possessing a stability in εᵣ values within ±15% of the X′ and R′ specifications of the Electronics Industries Alliance. For a high volumetric efficiency Class II capacitor, εᵣ should be >1000 over the full temperature range. Low dielectric losses are a further basic requirement.

Over the past 10 years, compositionally complex relaxor ferroelectrics with the perovskite ABO₃ crystal structure have been investigated extensively as high temperature dielectrics. Some of these satisfy (or come close to satisfying) the target specifications mentioned above. However they generally contain bismuth oxide which makes them thermodynamically incompatible with commercial multilayer ceramic capacitor (MLCC) manufacturing processes carried out under reducing atmospheres (Po₂<10⁻⁸ atm) and firing temperatures of ˜1000° C. These conditions permit low-cost nickel electrodes to be employed. The barrier to industrial translation of Bi-containing (or Pb-containing) dielectric ceramics arises from the similarity in Gibbs free energies of Ni/NiO and Bi/BiO_{1.5} couples under typical firing conditions in the MLCC industry. This brings the risk of chemical reduction of Bi ions (or Pb ions) in the dielectric layers and oxidation of the Ni electrode. This severely degrades both the electrical insulating properties of the dielectric and the conducting properties of the electrode.

WO-A-2008/155945 discloses multiphasic potassium-containing ceramic compositions comprising (1) (K₁₋ₓNaₓ)(Sr_{1-y-z}Ba_{y}Ca_{z})₂Nb₅O₁₅ (wherein 0<=x<0.2) having a tungsten bronze structure, (2) BaTiO₃ and related compounds having a perovskite structure and (3) element M.

JP-A-2018104209 discloses generally a ceramic composition which contains a main component having a tetragonal tungsten bronze structure represented as A₃(B1)(B2)₄O₁₅ and an accessory component being Mn, Cu, V, Fe, Co or Si.

U.S. Pat. No. 7,727,921B and US-A-2009/290285 disclose a ceramic composition comprising (1) a potassium-containing tungsten bronze type complex oxide having a formula (K₁₋ₓNaₓ)(Sr_{2-y-z}Ba_{y}Ca_{z})ₘNb₅O₁₅ (wherein 0<=x<0.2), (2) R selected from Y, La, Pr, Nd, Sm, Eu, Gd, Tb, Dy, Ho, Er, Tm, Yb and Lu and (3) M selected from Mn, V, Li, Si, Ni, Cr, Co, Fe, Zn, Mg, and Zr.

CN-A-107892572 discloses an undoped ceramic of formula Sr₂₋ₓCaₓNaNb₅O₁₅ where x is in the range 0.14 to 0.155.

JP-A-2018135254 discloses a multiphasic potassium-containing composition mainly composed of a tungsten bronze type complex oxide of formula (K₁₋ₓNaₓ)Sr₂Nb₅O₁₅ (wherein 0<=x<0.4) and an oxide of Ge.

The present invention is based on the recognition that incorporating low levels of certain dopants on A and B sites of the tungsten bronze Sr₂NaNb₅O₁₅ leads to a ceramic which is stable and exhibits high relative permittivity over a desirable temperature range.

Thus viewed from a first aspect the present invention provides a ceramic comprising (eg consisting essentially of or consisting of) a solid solution having a tetragonal tungsten bronze structure of general formula:

Sr_{2-d}Caₑ[α]_{f}[β]_{1-g}Nb₅₋ₕ[γ]ₕO₁₅₋ₖ

wherein:

[α] denotes one or more of the group consisting of the rare earth elements and actinides;
[β] denotes one or more of the group consisting of the alkali metals and the alkaline earth metals;
[γ] denotes one or more of the group consisting of zirconium, hafnium, titanium, manganese, tin, silicon and aluminium;
−0.1≤d≤0.2;
0<e≤0.1;
0≤f≤0.2;
0≤g≤0.2;
0≤h≤0.1;
f=d+g−e;
h≤f; and
k denotes an oxygen deficit sufficient to ensure charge balance.

The ceramic of the invention exhibits advantageously a relative permittivity which is consistently high over a range of temperatures which is compatible with nickel electrodes commonly used for the manufacture of commercial multilayer ceramic capacitor.

Preferably the ceramic is substantially monophasic.

Preferably the ceramic consists essentially of the solid solution. For example, the solid solution may be present in the ceramic in an amount of 90 wt % or more, particularly preferably 95 wt % or more, more preferably 99 wt % or more.

The ceramic may further comprise one or more metal oxide phases. The (or each) metal oxide phase may be a ternary oxide such as [β]NbO₃ (eg NaNbO₃) or a binary oxide such as [γ]O₂ (eg ZrO₂).

The (or each) metal oxide phase may be present in the ceramic in an amount of 10 wt % or less, preferably 5 wt % or less, more preferably 1 wt % or less. The (or each) metal oxide phase may be present in a trace amount.

The solid solution may be a partial solid solution. Preferably the solid solution is a complete solid solution.

The tetragonal tungsten bronze structure may be filled or unfilled. In a preferred embodiment, the solid solution has a pseudo tetragonal cell.

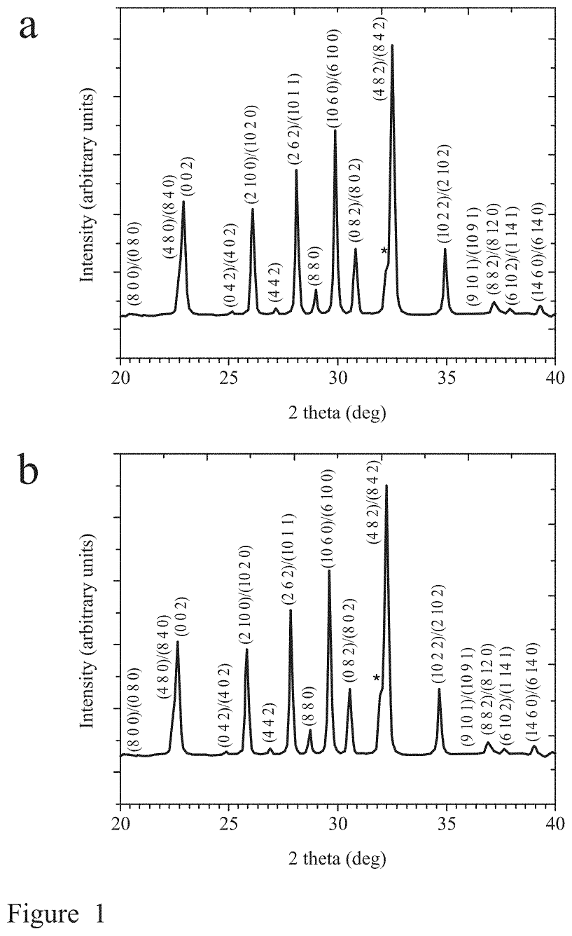

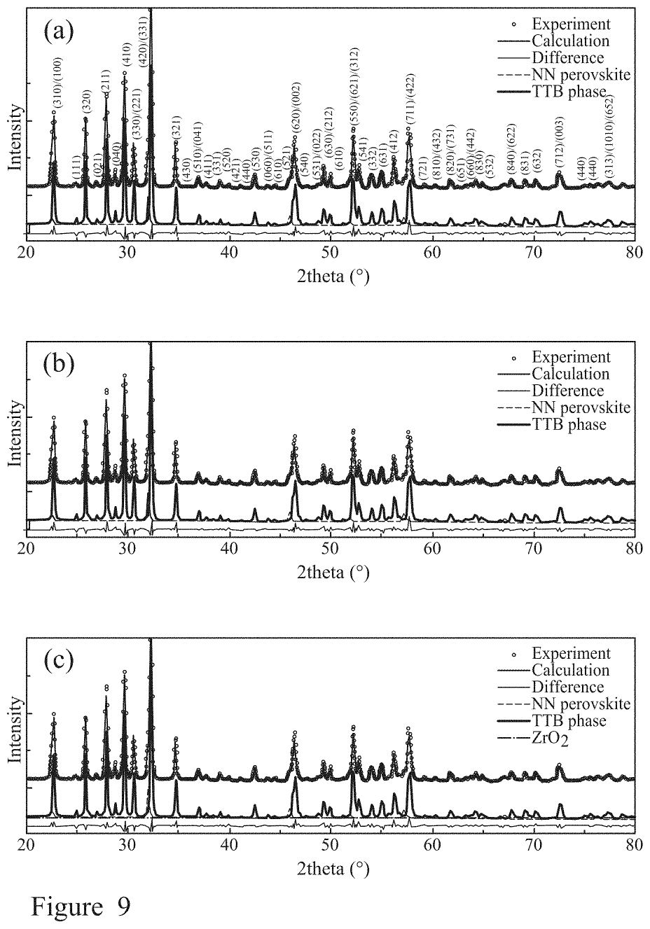

Preferably the ceramic has an X-ray diffraction pattern substantially as illustrated in FIG. 1 or 9.

In an embodiment of the invention, h<f. In an alternative embodiment of the invention, h=f.

In a preferred embodiment, 0<d≤0.2. Particularly preferably 0.01≤d≤0.15. More preferably 0.05≤d≤0.1.

In a preferred embodiment, 0.01≤e≤0.075. Particularly preferably 0.025≤e≤0.05.

Preferably 0<f≤0.2.

In a preferred embodiment, 0.01<f≤0.15. Particularly preferably 0.05≤f≤0.1.

Preferably 0≤g≤0.1. Particularly preferably g=0.

Preferably 0<h≤0.1.

In a preferred embodiment, 0.01<h≤0.075. Particularly preferably 0.025≤h≤0.05.

Typically 0≤k≤0.4. Preferably k=0.

Preferably [α] is yttrium (Y) or lanthanum (La). Particularly preferably [α] is yttrium (Y).

Preferably [β] is one or more alkali metals. Particularly preferably [β] is sodium (Na).

Preferably [γ] is zirconium (Zr).

In a preferred embodiment, the solid solution has a tetragonal tungsten bronze structure of general formula:

Sr_{2-d}CaₑY_{f}Na_{1-g}Nb₅₋ₕZrₕO₁₅₋ₖ.

In a preferred embodiment, the solid solution has a tetragonal tungsten bronze structure of formula:

Sr_{2-x-y}Caₓ[α]_{y}[β]Nb_{5-y}[γ]_{y}O₁₅

wherein:

0<x≤0.1; and
0≤y≤0.1.

In a preferred embodiment, 0.01≤x≤0.075. Particularly preferably 0.025≤x≤0.05.

Preferably 0<y≤0.1.

In a preferred embodiment, 0.01<y≤0.075. Particularly preferably 0.025≤y≤0.05.

In a preferred embodiment, the solid solution has a tetragonal tungsten bronze structure of formula:

Sr_{2-x-y}CaₓY_{y}Na Nb_{5-y}Zr_{y}O₁₅.

Preferably x and y are the same.

Preferably the ceramic exhibits a relative permittivity at 25° C. (ε_{r(25C)}) of 1000 or more, particularly preferably 1050 or more, more preferably 1200 or more, even more preferably 1300 or more.

Preferably the ceramic exhibits a relative permittivity (εᵣ) across the temperature range −55 to 270° C. (preferably −55 to 300° C.) which varies by ≤16% (particularly preferably by ≤15%, more preferably by ≤14%) compared with the relative permittivity at 25° C. (ε_{r(25C)}).

Preferably the ceramic exhibits a median relative permittivity (εᵣ) in the temperature range −55 to 270° C. (preferably −55 to 300° C.) of 1000 or more, particularly preferably 1050 or more, more preferably 1200 or more, even more preferably 1300 or more.

Preferably the ceramic exhibits a relative permittivity (εᵣ) across the temperature range −55 to 270° C. (preferably −55 to 300° C.) which varies by 16% (preferably by ≤15%, particularly preferably by ≤14%) compared with the median relative permittivity.

Preferably the ceramic exhibits a dielectric loss tangent (tan δ) of ≤0.03 (particularly preferably ≤0.025) across the temperature range −10 to 300° C. (preferably −55 to 300° C.).

The ceramic may be obtainable by sintering a sinterable form of a mixed metal oxide containing Sr, Ca, [α], [β], Nb and [γ].

In a preferred embodiment, the ceramic is obtainable by a process comprising:

(A) preparing an intimate mixture of a substantially stoichiometric amount of a compound of each of Sr, Ca, [α], [β], Nb and [γ];

(B) converting the intimate mixture into an intimate powder;

(C) inducing a reaction in the intimate powder to produce a mixed metal oxide;

(D) manipulating the mixed metal oxide into a sinterable form; and

(E) sintering the sinterable form of the mixed metal oxide to produce the ceramic.

Viewed from a yet further aspect the present invention provides a process for preparing a ceramic as hereinbefore defined comprising:

(A) preparing an intimate mixture of a substantially stoichiometric amount of a compound of each of Sr, Ca, [α], [β], Nb and [γ];

(B) converting the intimate mixture into an intimate powder;

(C) inducing a reaction in the intimate powder to produce a mixed metal oxide;

(D) manipulating the mixed metal oxide into a sinterable form; and

(E) sintering the sinterable form of the mixed metal oxide to produce the ceramic.

Preferably in step (A) the substantially stoichiometric amount of the compound of each of Sr, Ca, [α], [β], Nb and [γ] is expressed by the compositional formula:

Sr_{2-x-y}Caₓ[c]_{y}[β]Nb_{5-y}[γ]_{y}O₁₅

wherein α, β, γ, x and y are as hereinbefore defined.

The compound of each of Sr, Ca, [α], [β], Nb and [γ] may be independently selected from the group consisting of an oxide, nitrate, hydroxide, hydrogen carbonate, isopropoxide, polymer and carbonate.

The intimate mixture may be a slurry (eg a milled slurry), a solution (eg an aqueous solution), a suspension, a dispersion, a sol-gel or a molten flux.

Step (C) may include heating (eg calcining). Preferably step (C) includes stepwise or interval heating. Step (C) may include stepwise or interval cooling.

Preferably the intimate powder is a milled powder.

Step (E) may be stepwise or interval sintering. Preferably step (E) includes stepwise or interval sintering and stepwise or interval cooling.

Step (E) may be carried out in the presence of a sintering aid. The presence of a sintering aid promotes densification.

Step (D) may include milling the mixed metal oxide. Step (D) may include pelletising the mixed metal oxide.

Viewed from a still yet further aspect the present invention provides the use of a ceramic as hereinbefore defined as a dielectric in a capacitor.

Preferably the capacitor is a Class II capacitor.

Preferably in the use according to the invention the capacitor is operable at a temperature in the range −55 to 270° C., particularly preferably −55 to 300° C.

Preferably in the use according to the invention the capacitor is deployed in distributed engine control circuitry for aerospace or automotive applications, in geothermal energy exploration, in high voltage power electronics or in renewable energy applications.

The present invention will now be described in a non-limitative sense with reference to Examples and the accompanying Figures in which: FIG. 1. X-ray diffraction of crushed pellets after sintering at 1300° C. for 4 h: a) unmodified Sr₂NaNb₅O₁₅; b) Sr_{1.95}Ca_{0.025}Na_{1.0}Y_{0.025}Zr_{0.025}Nb_{4.975}O₁₅; c) Sr_{1.90}Ca_{0.05}Na_{1.0}Y_{0.05}Zr_{0.05}Nb_{4.95}O₁₅ (the asterisk indicates a NaNbO₃ phase and the other symbols indicate faint peaks due to monoclinic ZrO₂).

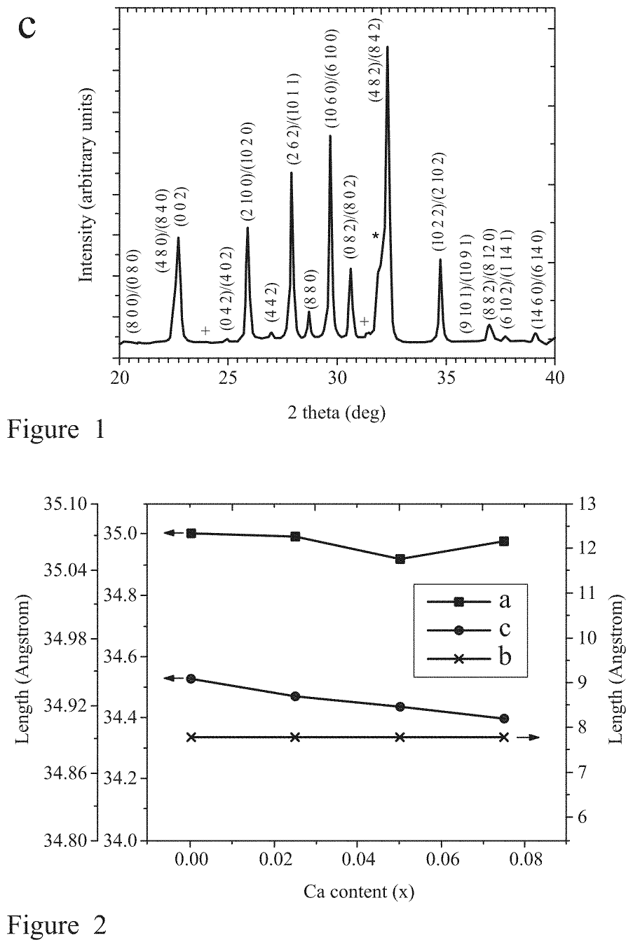

FIG. 2. Orthorhombic lattice parameters for different Ca contents (x) in Sr₂₋ₓCaₓNaNb₅O₁₅.

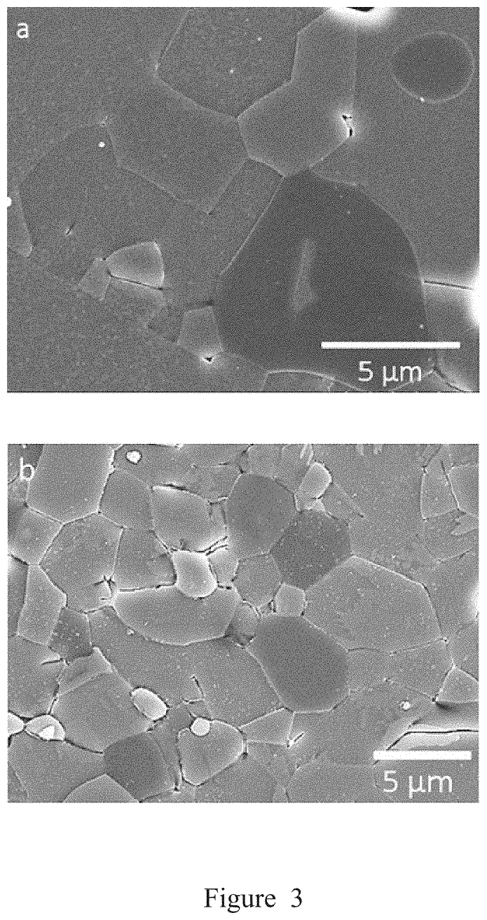

FIG. 3. SEM Micrographs of sintered, polished and etched ceramic Sr_{2-x-y}CaₓNa_{1.0}Y_{y}Zr_{y}Nb_{5-y}O₁₅ where (a) x=0.05, y=0 and (b) x=0.05, y=0.05.

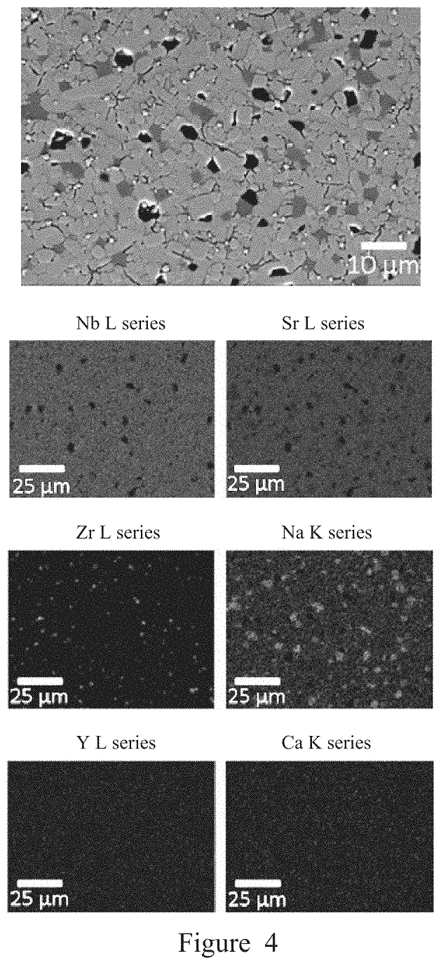

FIG. 4. SEM backscattered image of Sr_{2-x-y}CaₓNa_{1.0}Y_{y}Zr_{y}Nb_{5-y}O₁₅, x=0.05, y=0.05 and corresponding EDX compositional maps. The darker grains in the backscattered image correspond to Na rich regions; micron sized light contrast grains are Zr-rich.

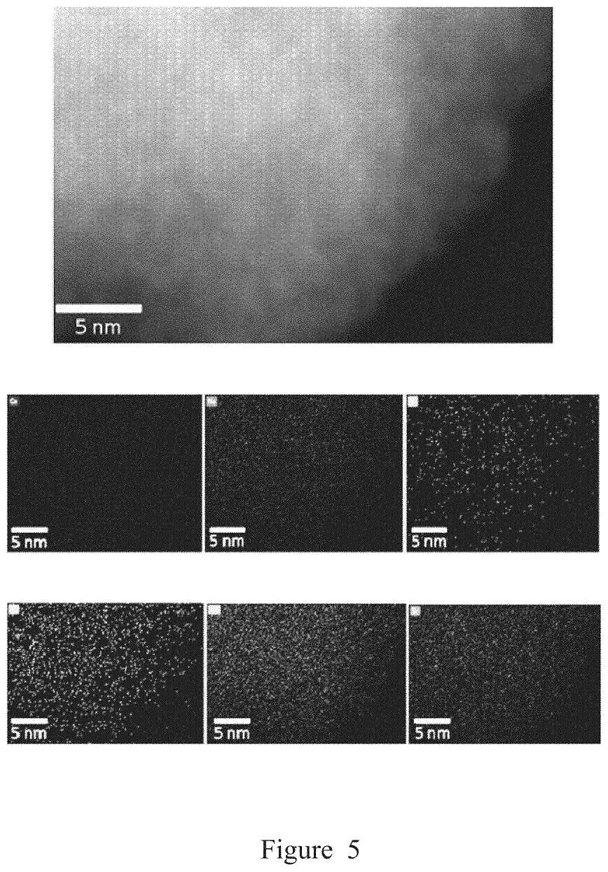

FIG. 5. High resolution HAADF-STEM image and EDX elemental maps of Sr_{2-x-y}CaₓNa_{1.0}Y_{y}Zr_{y}Nb_{5-y}O₁₅ (x=0.05, y=0.05). Mapping of Zr confirms the presence of Zr in the lattice of the main phase.

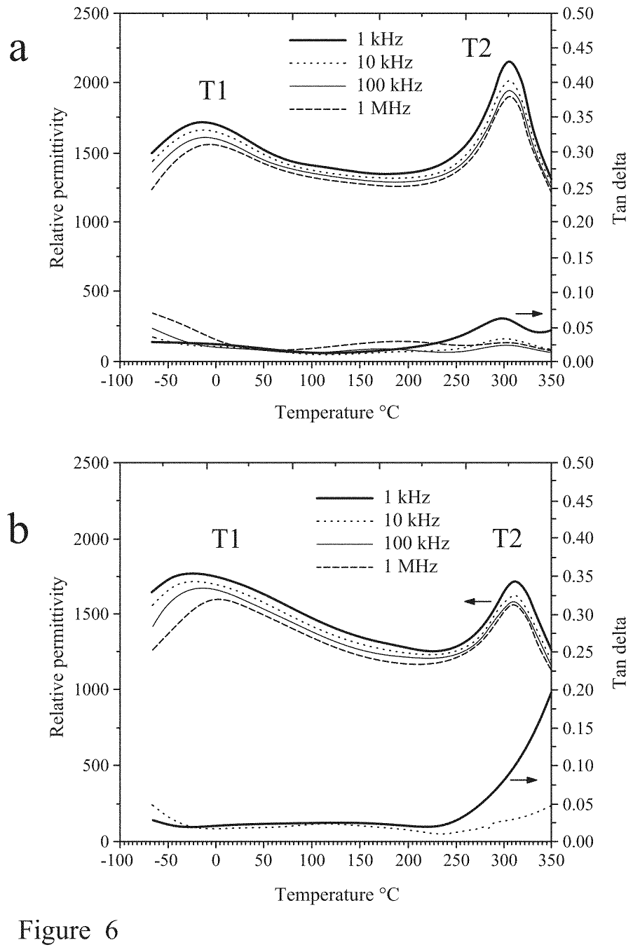

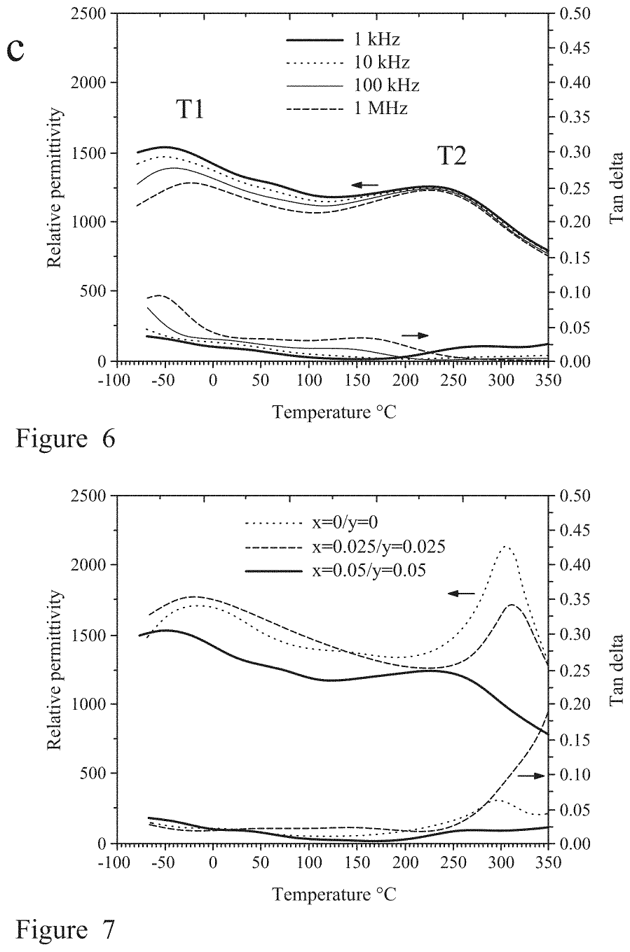

FIG. 6. Relative permittivity-temperature and loss tangent-temperature plots, highlighting a frequency dispersion of the lower temperature T1 peak: a) unmodified Sr₂NaNb₅O₁₅; b) Sr_{1.95}Ca_{0.025}Na_{1.0}Y_{0.025}Zr_{0.025}Nb_{4.975}O₁₅; c) Sr_{1.90}Ca_{0.05}Na_{1.0}Y_{0.05}Zr_{0.05}Nb_{4.95}O₁₅.

FIG. 7. Effect of CaYZr on relative permittivity-temperature and loss tangent-temperature plots (1 kHz data): black dashes Sr₂NaNb₅O₁₅; red dashes Sr_{1.95}Ca_{0.025}Na_{1.0}Y_{0.025}Zr_{0.025}Nb_{4.975}O₁₅; blue line Sr_{1.90}Ca_{0.05}Na_{1.0}Y_{0.05}Zr_{0.05}Nb_{4.95}O₁₅.

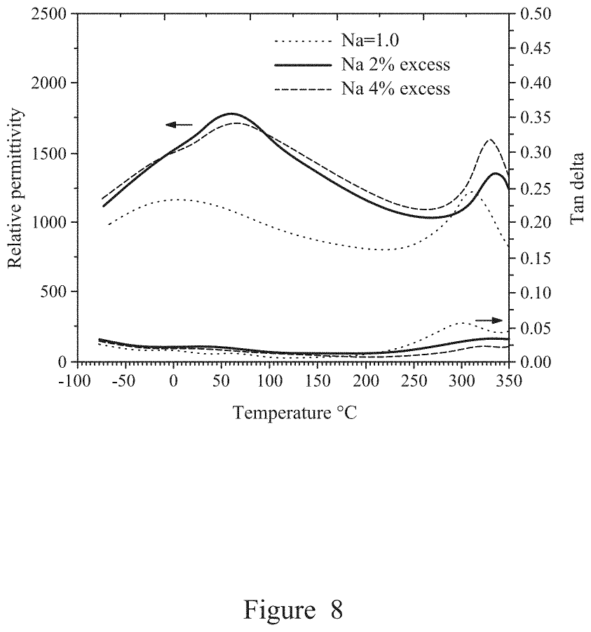

FIG. 8. Effect of excess Na₂O in lowering dielectric loss tangent values at temperatures 250-350° C. in Sr₂₋ₓCaₓNa_{1.0}Nb₅O₁₅ with x=0.025 at 1 kHz.

FIG. 9. Full-pattern refinements of X-ray powder diffraction data for crushed sintered pellets of Sr_{2-2z}Ca_{z}Y_{z}NaNb_{5-z}Zr_{z}O₁₅: a) z=0; b) z=0.025; c) z=0.05. The terms NN and TTB in the legends refer to a sodium niobate type perovskite second phase and the pseudo tetragonal tungsten bronze main phase respectively.

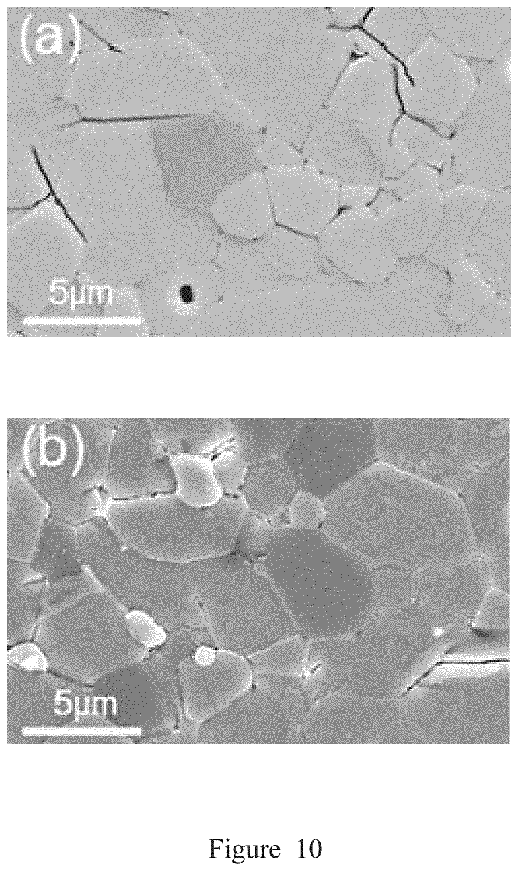

FIG. 10. SEM micrographs of Sr_{2-2z}Ca_{z}Y_{z}NaNb_{5-z}Zr_{z}O₁₅: (a) z=0 and (b) z=0.05 (sintered for 4 h at 1300° C.).

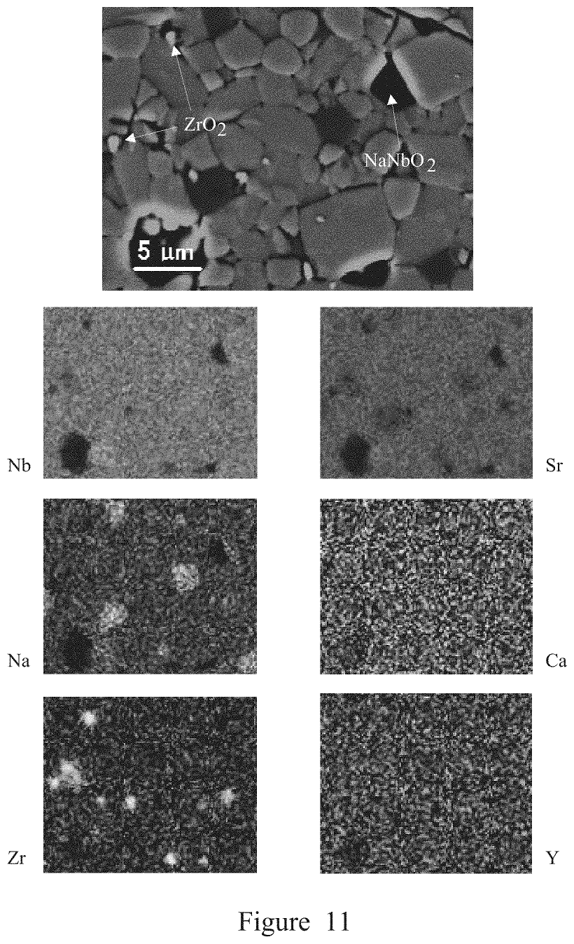

FIG. 11. SEM-EDX images of sample composition z=0.05 showing a secondary Na-rich phase consistent with the NaNbO₃ phase identified by XRD and ZrO₂ grains (sintered at 1300° C. for 4 h).

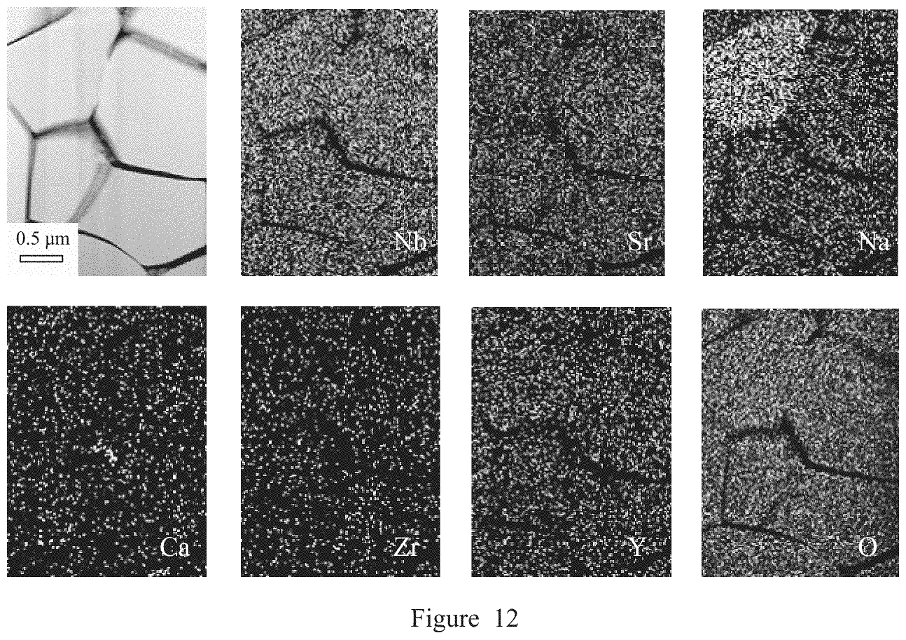

FIG. 12. Scanning TEM-EDX images confirming a lack of any detectable elemental gradation across grains—in contrast to conventional perovskite BaTiO3 X7R temperature-stable dielectrics. Striations in HAADF* image (top left) are a ‘curtaining’ artefact of the FIB-SEM thinning method used to prepare the TEM specimen. * HAADF=high angle annular dark-field.

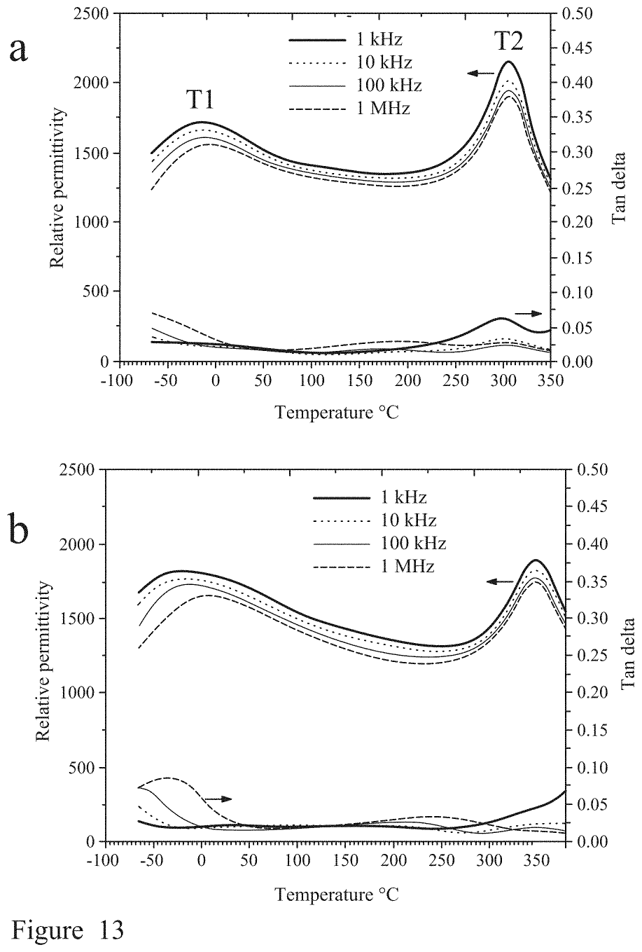

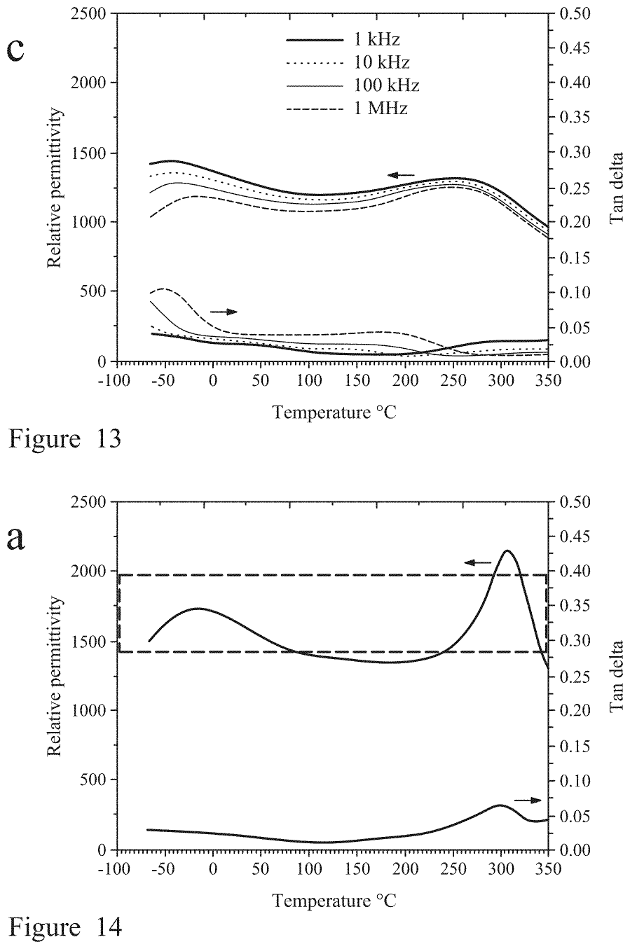

FIG. 13. Relative permittivity-temperature and loss tangent-temperature responses for Sr_{2-2z}Ca_{z}Y_{z}NaNb_{5-z}Zr_{z}O₁₅: a) z=0; b) z=0.025; c) z=0.05.

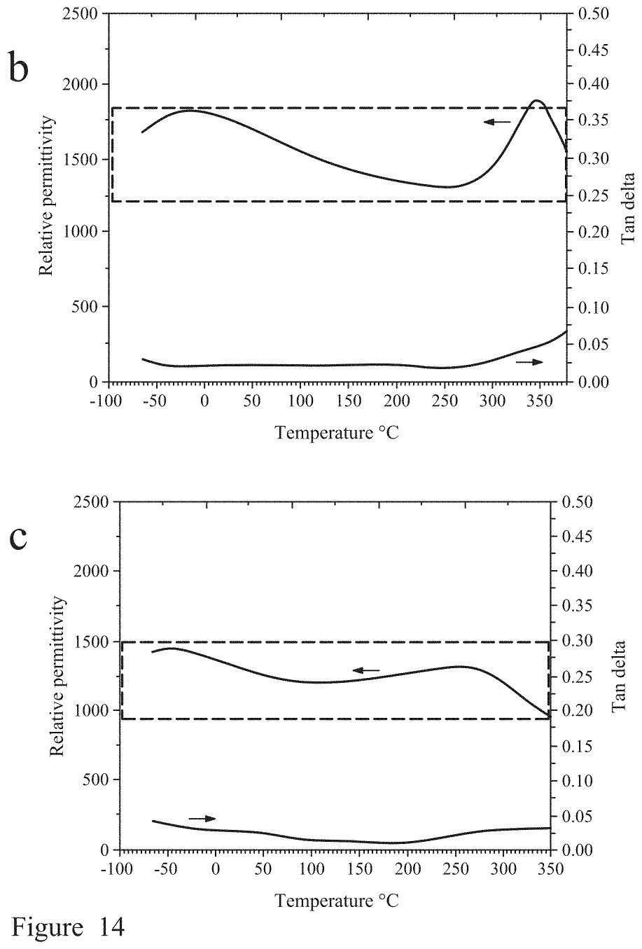

FIG. 14. Comparisons of the 1 kHz relative permittivity which highlights the stability in εr values from −65° C. to >300° C. in Sr_{2-2z}Ca_{z}Y_{z}NaNb_{5-z}Zr_{z}O₁₅: (a) z=0; (b) z=0.025; (c) z=0.05. The dashed outline indicates the ±15% limits required by the EIA. Dielectric loss tangent plots are also shown.

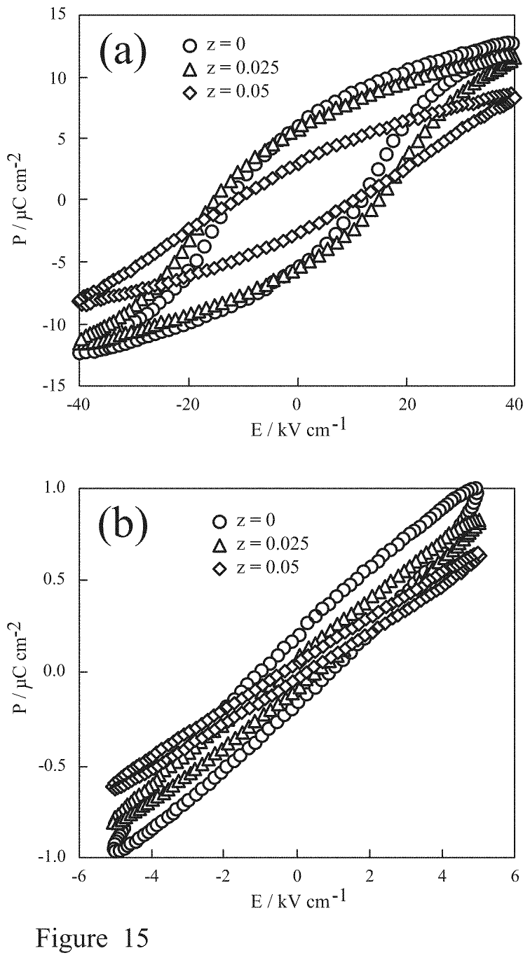

FIG. 15. Comparison of P-E loops for (a) Eₘₐₓ=40 kV cm⁻¹ and (b) Eₘₐₓ=5 kV cm⁻¹.

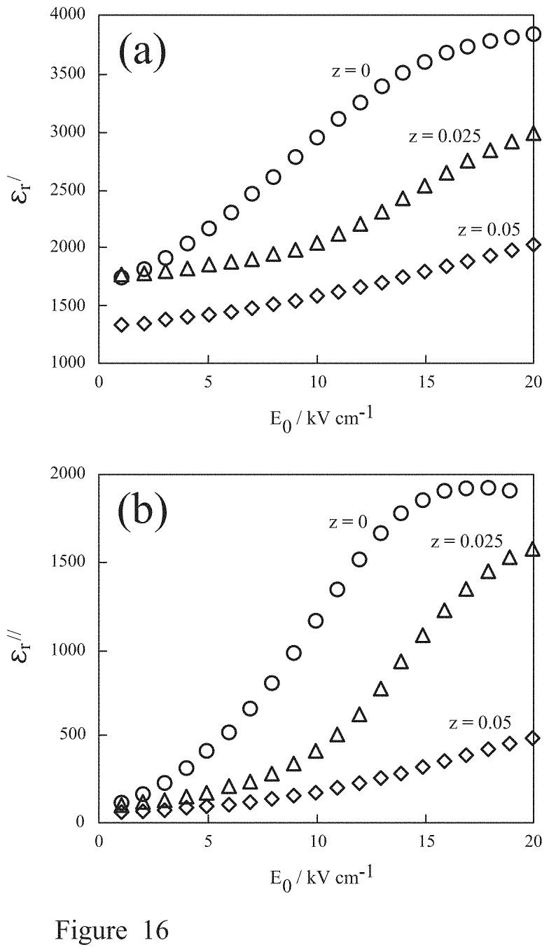

FIG. 16. Variations in (a) real and (b) imaginary parts of relative permittivity as a function of increasing electric field amplitude

### EXAMPLE 1

### Experimental

Samples of Sr₂NaNb₅O₁₅, Sr₂₋ₓCaₓ NaNb₅O₁₅ (x=0.025, 0.05 and 0.075) and Sr_{2-x-y}CaₓY_{y}NaNb_{5-y}Zr_{y}O₁₅ were prepared using a mixed oxide synthesis. The starting reagents in powder form were strontium carbonate (Aldrich, 99.9%), calcium carbonate (Aldrich, >99%), sodium carbonate (Sigma-Aldrich, 99.95%), niobium oxide (Alfa Aesar, 99.9%), yttrium oxide (Alfa Aesar, 99.9%) and zirconium oxide (Aldrich, 99%). The powders were mixed in appropriate ratios before ball-milling for up to 24 hours using stabilised-zirconia grinding media in isopropanol. Dried powders were calcined at 1200° C. for 6 hours (heating rate 5° C./min) in high purity alumina crucibles. The calcined powders with 2 wt % of binder (Optapix AC112, Zschimmer & Schwarz) were ball milled in water for 24 hours, dried and passed through a 300 μm mesh nylon sieve, before being pressed uniaxially at 100 MPa (for 90 s) in a 1 cm diameter steel die. Pellets were placed on a powder bed of the same composition in high purity alumina crucibles and covered to a depth of ˜1 cm with powder of the same composition. For sintering, the compacted pellets were first heated at 1° C./min to 550° C. and held for 4 hours to burn out the binder. The pellets were then heated at 5° C./min to (for example) 1300° C. or 1350° C. and held at this temperature for 4 hours.

Densities were measured from pellet dimensions and mass. The theoretical density was obtained from the nominal unit cell contents and measured lattice parameters. Phase analysis by X-ray powder diffraction (XRD) was carried out using a Bruker D8 X-ray powder diffractometer. Unit cell lattice parameters were obtained by Rietveld refinement. Scanning electron microscopy (SEM) and transmission electron microscopy (TEM) were each used with energy dispersive X-ray capability (EDX) for microstructural evaluation and to provide compositional information. Relative permittivity (εᵣ) and loss tangent (tan δ) were measured as a function of temperature at fixed frequencies using a HP4284 LCR meter (Hewlett Packard) for the temperature range 20 to 400° C. For temperatures down to −70° C., an environmental chamber was used (Tenney). Silver electrodes were applied to opposite pellet faces (Sun Chemical, Gwent Electronic Materials).

### Results and Discussion

### Structural Analysis

XRD patterns of powders of crushed sintered pellets of Sr_{2-X}CaₓNaNb₅O₁₅ (see FIG. 1 for x=0.0 and 0.05) were generally similar to those reported in the literature. A shoulder to the peak at 32.24°2θ corresponds to the main peak in NaNbO₃ (see García-González, E., Torres-Pardo, A., Jiménez, R. and González-Calbet, J. (2007). Structural Singularities in Ferroelectric Sr₂NaNb₅O₁₅. Chemistry of Materials, 19(14), pp. 3575-3580 and Torres-Pardo, A., Jiménez, R., González-Calbet, J. and García-González, E. (2011). Structural Effects Behind the Low Temperature Nonconventional Relaxor Behavior of the Sr₂NaNb₅O₇s Bronze [online] Inorganic Chemistry, 50(23), pp. 12091-12098).

There is ambiguity in the literature as to whether diffraction patterns of this type of tungsten bronze can be indexed as tetragonal or on the basis of a larger orthorhombic cell which takes account of a supercell arising from NbO₆ octahedral tilting. The diffraction patterns in FIG. 1 are indexed according to an orthorhombic cell as reported for Sr₂NaNb₅O₁₅ by García-González [supra]. Solid solution formation involving Ca substitution for Sr (and possibly Na) was confirmed by the slight shift in lattice parameters (see FIG. 2).

Measured densities were in the range 4.7-4.8 g/cm³ corresponding to ˜88-92% of the theoretical density. Grain sizes were as expected for a ceramic prepared by a conventional mixed oxide synthesis (typically <7 μm—see FIG. 3).

Contrast variations in backscattered SEM images in ˜5% of the grains implied a compositional variation which was shown to be due to grains with a higher Na content than the matrix by SEM-EDX elemental mapping (see FIG. 3). These grains are the NaNbO₃ phase detected by XRD.

The effect of incorporating Y and Zr (assuming equal levels of substitution of Y for Sr and Zr for Nb) in a solid solution Sr_{2-x-y}CaₓY_{y}NaNb_{5-y}Zr_{y}O₁₅ was investigated for x=0.025 and y=0.025 and for x=0.05 and y=0.05. There was little difference in the XRD peak positions compared to when y=0 (see FIG. 1). However a small amount of zirconia was detected.

SEM-EDX elemental mapping of a YZr modified sample is presented in FIG. 4. This highlights grains that are Na-rich (similar to those observed for y=0 samples). There were also Zr-rich grains evident which was consistent with the ZrO₂ peaks detected by XRD (see FIG. 1). The latter findings cast doubt on the assumed charge balance mechanism of Zr⁴⁺ ion substitution for Nb⁵⁺ ions (Zr_{N}b) to complement an equivalent level of Y³⁺ ion substitution for Sr²⁺ ions (Ysr). However further microstructural analysis using high resolution S/TEM and EDX (see FIG. 5) revealed the presence of Y and Zr in all matrix grains and confirmed lattice substitutions of both elements into the Sr₂₋ₓCaₓNaNb₅O₁₅ lattice. The amount of ZrO₂ decreased significantly for a sintering temperature of 1350° C. compared with 1300° C. indicating that (in-part) the free ZrO₂ was a result of incomplete solid state reaction.

The SEM and S/TEM EDX analysis each provided evidence of ˜ 1 μm zirconia grains in samples sintered at 1300° C. Zirconia was also present but in a reduced amount in samples sintered at 1350° C. There was no evidence of any yttrium containing secondary phase. Therefore the SEM and S/TEM EDX analysis results imply that the defect chemistry is more complex than is assumed by the starting compositional formula. The composition of the main phase will have deviated slightly from the nominal solid solution formula. In the sintered ceramic, charge balance could involve mainly Sr (Ca) and Na substitutions but with more limited B site substitution than first anticipated. This would have the effect of generating a surplus of Na, Sr and Zr ions which is consistent with the phase assembly detected. A separate study of phase equilibria and defect chemistry would be required to understand structure-property relationships in detail and to establish the optimum ceramic processing conditions. Thus the combined results of XRD, SEM and S/TEM-EDX suggest the ceramic products with the most useful dielectric properties may best be represented by the general formula Sr_{2-d}CaₑY_{f}Na_{1-g}Nb₅₋ₕZrₕO₁₅₋ₖ where f=d+g−e and h<f.

### Dielectric Properties

Sr₂NaNb₅O₁₅ is characterised by two dielectric peaks in the temperature range of interest (see FIG. 6a). The higher temperature peak at 300° C. of similar tungsten bronzes is reported to correspond to the formation (on cooling) of a supercell involving out of plane (ab) octahedral tilts. These subtle structural changes generate ferroelectric behaviour. Reasons for the lower temperature peak at 0° C. are less well understood. It coincides with a change in thermal expansion coefficient suggesting that the composition is ferroelastic in character although no corresponding structural deviation has been detected (see Toledano, J. and Pateau, L. (1974). Differential thermal analysis of ferroelectric and ferroelastic transitions in barium sodium niobate. Journal of Applied Physics, 45(4), pp. 1611-1614).

For Sr₂NaNb₅O₁₅, the higher temperature peak occurred at 305° C. (T2) and the lower temperature peak occurred at −15° C. (T1) (see FIG. 6a). The latter showed frequency dispersion akin to that of a relaxor ferroelectric. The effect of Ca substitution was to increase the relative magnitude of the lower temperature T1. The T2 peak became slightly more diffuse (see FIGS. 6b and 6c).

The consequences on εᵣ−T response of modifications by Y and Zr at x=0.025 and 0.05 are shown in FIG. 7. For both compositional modifications, the T2 peak diminished in magnitude, most notably for x=0.05, y=0.05. The T2 peak was much more diffuse for x=0.05, y=0.05 and its temperature was reduced.

As a consequence of these changes, at a composition x=0.025, y=0.025 and for a sintering temperature of 1300° C. (density<90% theoretical), the values of permittivity fell in the range εᵣ=1076±14% across the temperature range −55 to 300° C. (where 1076 is the median εᵣ value and occurred at 85° C.). However for samples of higher density (˜93% theoretical) obtained by sintering at 1350° C. for 4 h, εᵣ=1510±16% from −70° C. to 300° C. The corresponding dielectric loss tangent value was <0.035 from −70° C. to 260° C. (see FIG. 7) increasing to 0.09 between 260° C. and 300° C.

In samples with higher levels of Y and Zr (ie x=0.05, y=0.05) an excellent combination of dielectric properties was observed in the temperature range −70 to 270° C. This upper temperature would meet the demands of most proposed power electronics applications. The permittivity values relative to the 25° C. point were: ε_{r(25C)}=1370±14% from −70 to 270° C. The temperature stability specification of capacitors is normally described in terms of the % variation relative to a room-temperature value. Hence the εᵣ median value of x=0.05, y=0.05 at 25° C. is highly advantageous. Dielectric loss tangent values were 0.025 from −12 to 290° C. increasing to 0.03 at −32° C. and to 0.038 at −70° C. (see FIG. 7).

The foregoing dielectric properties of CaYZr modified Sr₂NaNb₅O₁₅ ceramics are summarised in Tables 1a and 1b below.

Based on the premise that some of the Na₂O in the ceramic may have been lost due to evaporation during sintering, the effect of adding excess Na₂CO₃ to the starting mixture was investigated. Additions of 2 wt % and 4 wt % caused an increase in the peak temperatures T1 and T2 and in the εᵣ values (see FIG. 8). This implies that defect structures were moderated by such additions. This hypothesis was confirmed by the lower dielectric losses in the high temperature regime (>250° C.) with tan δ decreasing to below 0.025. This implies a lower contribution from electrical conduction mechanisms. However the variability in εᵣ between −55 and 250-300° C. increased to beyond 15%.

### Conclusions

A very promising bismuth- and lead-free ceramic compositional system for new Class II dielectric materials has been demonstrated to have high and stable relative permittivity and low dielectric loss over a very wide temperature range of −70° C. (or lower) to 270-300° C. for the nominal solid solution series: Sr_{2-x-y}CaₓY_{y}NaNb_{5-y}Zr_{y}O₁₅. For x=0.05, y=0.05 the value of relative permittivity at 25° C. was 1370 with only ±14% variation in values for temperatures between −70 and 270° C. Dielectric loss tangent values were <0.03 except for the range −32 to −70° C. where they rose slightly to 0.038. High resolution scanning transmission electron microscopy with energy dispersive X-ray analysis confirmed Ca, Y and Zr substitution in the crystal lattice of the parent tungsten bronze Sr₂NaNb₅O₁₅ was achieved but the presence of minor amounts of zirconia and sodium niobate phases imply the composition of the main phase deviates slightly from the nominal solid solution formula (although the amount of secondary phases decreased when sintering temperature was increased from 1300 to 1350° C. due to an increased degree of solid state reaction). The properties indicate that these bismuth- and lead-free tungsten bronze niobates are excellent candidates as high temperature capacitor materials. Thermodynamic calculations predict they are compatible with nickel electrode multilayer ceramic capacitor co-firing techniques.

TABLE 1
Summary of key dielectric properties of ceramics of
Sr_{1.95}C_{0.025}Na_{1.0}Y_{0.025}Zr_{0.025}Nb_{4.975}O₁₅ (sintered at 1350° C.) and
Sr_{1.90}Ca_{0.05}Na_{1.0}Y_{0.05}Zr_{0.05}Nb_{4.95}O₁₅ (sintered at 1300° C.)
a) Temperature Range −70 to 270° C.: summary 1 kHz dielectric data

| Sample | | | εᵣ median | ±% εᵣ ₋70 | tanδₘₐₓ −70- | | | |
|---|---|---|---|---|---|---|---|---|
| Code | Intended Product Composition | density | (T) | to 270° C. | 270° C. | tanδ <0.035 | tanδ <0.03 | tanδ <0.025 |
| x = 0.025 | Sr_{1.95}C_{0.025}Na_{1.0}Y_{0.025}Zr_{0.025}Nb_{4.975}O₁₅ | ~92% | 1510 | 16% | 0.045 | −70-260° C. | −70-250° C. | −60-245° C. |
| y = 0.025 | | | (85° C.) | | | | | |
| x = 0.05 | Sr_{1.90}Ca_{0.05}Na_{1.0}Y_{0.05}Zr_{0.05}Nb_{4.95}O₁₅ | ~93% | 1370 | 14% | 0.038 | −50-381° C. | −32-370° C. | −12-290° C. |
| y = 0.05 | | | (25° C.) | | | | | |

b) Temperature Range −70 to 300° C.: summary 1 kHz dielectric data (sintering T = 1350° C. and 1300° C. respectively)

| Sample | | | εᵣ median | ±% εᵣ −70 | tanδₘₐₓ −70 | | | |
|---|---|---|---|---|---|---|---|---|
| Code | Intended Product Composition | density | (T) | to 300° C. | to 300° C. | tanδ <0.035 | tanδ <0.03 | tanδ <0.25 |
| x = 0.025 | Sr_{1.95}Ca_{0.025}Na_{1.0}Y_{0.025}Zr_{0.025}Nb_{4.975}O₁₅ | ~92% | 1510 | 16% | 0.09 | −70-260° C. | −70-250° C. | −60-245° C. |
| y = 0.025 | | | (85° C.) | | | | | |
| x = 0.05 | Sr_{1.90}Ca_{0.05}Na_{1.0}Y_{0.05}Zr_{0.05}Nb_{4.95}O₁₅ | ~93% | 1271 | 26% | 0.038 | −50-381° C. | −32-370° C. | −12-290° C. |
| y = 0.05 | | | (82° C.) | | | | | |

### EXAMPLE 2

### Experimental

In this Example, the chemical formula of the parent niobate phase (Sr₄Na₂Nb₁₀O₃₀) is expressed as Sr₂NaNb₅O₁₅ (SNN) for convenience. The substituted compositions are expressed assuming a solid solution formula Sr_{2-2z}Ca_{z}Y_{z}NaNb_{5-z}Zr_{z}O₁₅. The assumption is that Ca²⁺ and Y³⁺ substituents will occupy A1/A2 sites and Zr⁴⁺ will occupy Nb⁵⁺ (B) sites. C cites will remain empty. Sample formulations with z=0, 0.025 and 0.05 were prepared using a mixed oxide synthesis. The compositions correspond to a very low level of substitution. Only 1.25 at. % of the Sr², (A) sites are substituted by Y³⁺ in the composition z=0.025 and 2.5 at. % in the composition z=0.05. For B sites, the levels of substitution of Zr⁴⁺ for Nb⁵⁺ are 0.05 at. % and 1 at. % respectively for compositions z=0.025 and 0.05.

The starting reagents were strontium carbonate (Aldrich, 99.9%), calcium carbonate (Aldrich, >99%), sodium carbonate (Sigma-Aldrich, 99.95%), niobium oxide (Alfa Aesar, 99.9%), yttrium oxide (Alfa Aesar, 99.9%) and zirconium oxide (Alfa Aesar, 99.7%). Powders were mixed in appropriate ratios before ball-milling for up to 24 hours using stabilised zirconia grinding media in isopropanol. Dried powders were calcined at 1200° C. for 6 hours (heating rate 5° C./min) in high purity alumina crucibles. The calcined powders with the addition of 2 wt. % of binder (Optapix AC112, Zschimmer & Schwarz) were ball milled in water for 24 hours, dried and passed through a 300 μm mesh nylon sieve, before pressing uniaxially at 100 MPa (for 90 s) in a 1 cm diameter steel die. After uniaxial pressing, the green pellets were isopressed (200 MPa for 5 minutes) in an isostatic press (Stanstead fluid power, Essex, UK). Binder burn-out was performed at a heating rate of 1° C./min to a dwell temperature of 550° C. and held for 5 hours. Sintering was carried out after embedding the pellets in a powder of the same composition. Maximum densities were obtained at a sintering temperature of 1300° C. or 1350° C. Dwell times were 4-5 hours. Sintered ceramic densities were measured from measured pellet dimensions and mass. The theoretical density was estimated from the nominal unit cell contents and measured lattice parameters.

Phase analysis by powder X-ray diffraction (XRD) was carried out using a Bruker D8 X-ray powder diffractometer. Unit cell lattice parameters of an adopted pseudo-tetragonal structure were obtained by full pattern Rietveld refinement using TOPAS 5.0 software (Bruker AXS, Karlsruhe, Germany). In the refinement analysis, the peak shape function was determined by the fundamental parameters of the X-ray diffractometer geometry. The refined parameters are background function coefficient, lattice constant, scale factor and atomic coordination.

In order to prepare specimens for microstructural characterisation by scanning electron microscopy, ceramic pellets were mounted in epoxy resin (Epothin, Buehler) and ground with P240, P600 and P2500 silicon carbide paper. Subsequent sequential polishing was carried out using Texmet P microcloths with MetaDi 2 diamond suspensions of decreasing particle size: 9 μm, 3 μm and 1 μm. A final polish was carried out with ChemoMet and MasterMet 0.06 am colloidal silica on a Buehler EcoMet 300 grinder/polisher. Chemical etching was carried out with a 2:1 ratio of hydrofluoric acid and concentrated nitric acid for 90 seconds at room temperature.

Scanning electron microscopy (SEM) was performed using a Hitachi SU8230 high performance cold field emission instrument fitted with an Oxford Instruments Aztec energy dispersive X-ray analysis (EDX) system with 80 mm² X-Max SD detector and analysis software. For transmission electron microscopy (TEM), thin sample lamellae were prepared via the in-situ lift-out method using a FEI Helios G4 CX Dual Beam—High resolution monochromated, field emission gun, scanning electron microscope (FEG-SEM) with precise Focused Ion Beam (FIB). In the Dual Beam microscope, 500 nm of platinum (Pt) was electron beam deposited (at 5 kV, 6.4 nA for the electron source) onto the surface of the target area. This was followed by a second Pt layer (1 μm) using the FIB (at 30 kV, 80 pA for the liquid Ga ion source). An initial lamella was cut (by the FIB at 30 kV, 47 nA), before a final cut-out was performed (at 30 kV, 79 nA). Final thinning and polishing of the lamellae to electron transparency was performed with a low energy ion beam (5 kV, 41 pA). The lamellae were attached, using ion beam deposited Pt onto a copper FIB lift-out grid (Omniprobe, USA) mounted within the SEM chamber (in-situ) ready for transfer to the TEM. The lamellae were imaged using a FEI Titan Themis³ 300 kV TEM fitted with a SuperX EDX system and Velox processing software.

For electrical measurements, silver electrodes were applied to opposite pellet faces (Sun Chemical, Gwent Electronic Materials). Relative permittivity, εᵣ, and loss tangent (tan δ) were measured at low-field as a function of temperature at fixed frequencies using a Hewlett Packard, HP4284 LCR analyser. An environmental chamber was used for lower temperatures down to −65° C. (TJR; Tenney Environmental-SPX, White Deer, Calif.). Ferroelectric hysteresis measurements were carried out using a HP33120A function generator in combination with a HVA1B high voltage amplifier (Chevin Research, Otley, UK), using a sinusoidal electric field waveform with a frequency of 2 Hz. The measured electric field-time and current-time waveforms were processed to yield polarisation-electric field (P-E) loops and effective complex permittivity values using the method described by M. Stewart, M. G. Cain, D. A. Hall, Ferroelectric hysteresis measurement & analysis, National Physical Laboratory Report CMMT(A), 152[1] (1999).

### Results and Discussion

Full-pattern refinements of X-ray powder diffraction data for crushed sintered pellets are shown in FIG. 9. The secondary phase NaNbO₃ was present in all three samples. Increasing the calcination and sintering times failed to eliminate the extra phase. Thus even for unmodified SNN the notional formula Sr₂NaNb₅O₁₅ may be inaccurate. For example, the Na rich secondary phase may be due to Sr²⁺ occupancy of a fraction of the perceived Na⁺ sites, giving a formula Sr₂₊ₓNa₁₋₂ₓNb₅O₁₀. The monoclinic ZrO₂ secondary phase was identified only in the z=0.05 sample. All phases were included in the Rietveld refinements.

No convincing evidence was found from XRD of weak extra superlattice reflections at around 20 °2θ or 37 °2θ which others have observed with the aid of electron diffraction and attributed to an orthorhombic unit cell (Space Group Im2a). The lack of any distinct supercell reflections in the XRD patterns prompted indexing on tetragonal axes and refinement of the data on the basis of space group P4bm. Crystallographic data refined on P4bm are summarised in Table 2. The modifications by Ca²⁺, Y³⁺, Zr⁴⁺ produced a slight contraction in cell volume (see Table 2) consistent with solid solution formation.

TABLE 2
Summary of (pseudo) tetragonal lattice parameters,
goodness of fit, R_{wp} and phase fractions from Rietveld analysis for
Sr_{2-2z}Ca_{z}Y_{z}NaNb₅—_{z}Zr_{z}O_{15.}

| | | | | R_{wp} | % |
|---|---|---|---|---|---|
| Composition | a (Å) | c (Å) | V (Å³) | % | NaNbO₃ |
| z = 0 | 12.365(90 | 3.8958(2) | 595.73(3) | 4.58 | 5.0 |
| z = 0.025 | 12.362(9) | 3.8920(1) | 594.84(9) | 4.99 | 7.4 |
| z = 0.05 | 12.363(0) | 3.8861(1) | 593.97(3) | 4.27 | 7.3 |
| | | | | | (+2.5 ZrO₂) |

Scanning electron micrographs of polished and etched sections of z=0 and z=0.05 are shown in FIG. 10. Observed grain sizes were similar (<10 μm) for both compositions. Densities were 92-93% of estimated theoretical values. The possibility of elemental segregation within the grains was investigated by SEM-EDX and TEM-EDX. For X7R BaTiO₃ based capacitor materials, a core-shell grain structure brought about by a variety of additive oxides is responsible for inducing a temperature stable permittivity response from −55° C. to 125° C. Thus it was important to establish if a comparable microstructure-strain mechanism was responsible for flattening the εᵣ−T response of SNN. The SEM-EDX analysis for z=0.05 showed no elemental gradation within grains (see FIG. 11). The existence of secondary grains of sodium niobate and zirconia identified in XRD patterns with grain sizes of ˜5 μm and ˜1 μm respectively was confirmed by the SEM-EDX analysis. There was also some evidence from EDX for the presence of Sr in the sodium niobate grains. More detailed analysis using TEM-EDX confirmed an absence of core-shell grain structures, or indeed any form of elemental gradation within individual grains (see FIG. 12).

The relative permittivity-temperature (εᵣ−T) response of the parent tungsten bronze Sr₂NaNb₅O₁₅ ceramic (SNN) is presented in FIG. 13a. The higher temperature dielectric peak (at 305° C.) is denoted T₂. For other tungsten bronzes, this dielectric anomaly is reported to correspond to the formation (on cooling) of a supercell which induces ferroelectric behaviour: hence T₂ represents the Curie point. Structural correlations are less well understood in the context of the lower temperature dielectric peak T₁, which occurs at −14° C. in SNN (1 kHz) and shows frequency dispersion similar to a relaxor ferroelectric. An accompanying change in thermal expansion coefficient for related tungsten bronzes implies that the T₁ peak corresponds to a ferroelastic transition but no associated structural deviations have been detected. For z=0 (SNN), the ‘standard’ dielectric peaks created a variation in εᵣ of ±22% across the important temperature range −55° C. to 300° C. (see FIG. 13a). This is well outside the R-type±15% stability level required of a Class II capacitor material. Consequently partial substitution of Sr²⁺ by Ca², was investigated for Sr₂₋ₓCaₓNaNb₅O₁₅ x<0.1. The εᵣ−T responses of SNN and Ca-SNN ceramics of comparable densities were generally similar. Further chemical modifications involving co-substitution of Ca²⁺, Y³⁺ for Sr², and Zr⁴⁺ for Nb⁵⁺ were investigated in an attempt to suppress the temperature variability in permittivity and attain R-type performance. The substituent ions were selected on the basis of ionic radii and valence considerations.

For the Ca²⁺, Y³⁺, Zr⁴⁺ modified SNN sample composition z=0.025, the T₂ peak temperature increased to 345° C. from a value of 305° C. in unmodified SNN (at 1 kHz). There was also a decline in the ε_{r max} value due to increased broadening (see FIG. 13b). For the lower temperature peak, there was very little change in peak temperature T₁ with substituent doping (−18° C. compared to −14° C. for SNN z=0) but there was an increase in frequency dispersion. For sample composition z=0.025 the difference in temperature (AT) of εᵣₘₐₓ temperatures (Tm) between frequencies 1 kHz and 1 MHz was 25° C. compared with 10° C. for unmodified SNN (z=0).

For a higher level of chemical substitution (z=0.05) the T₂ anomaly was displaced to 255° C. which is 90° C. below the T₂ peak for z=0.025 (see FIG. 13c). This non-monotonic shift of T₂ with z indicates a complex interplay between substitution level and temperature of the dielectric anomalies which may well relate to alterations in defect structures (possibly affecting NbO₆ tilts in the case of T₂). The T₂ anomaly also became significantly more diffuse as the level of substitution increased. As a result, the εᵣₘₐₓ value at T₂ was approximately 60% of that observed for unmodified SNN (z=0). There was also an increase in broadening of the T1 peak (see FIG. 13c) but less so than for T2.

The net effect of these chemical modifications on peak temperatures and peak profiles was to achieve the requisite εᵣ±15%, R-type consistency in εᵣ over very wide ranges of temperature. For z=0.025, the measured variation in the εᵣ data was within ±13% of a median value of 1565 for temperatures extending from −65° C. to 325° C. (the median εᵣ value occurred at ˜105° C.). A further improvement in temperature-stability was achieved for higher levels of Ca²⁺, Y³⁺ and Zr⁴⁺ substitution. The z=0.05 sample composition gave a median value of εᵣ=1310 with a ±10% variation from temperatures of −65° C. to 300° C. Very relevant to consideration as a capacitor material, the median value of εᵣ in z=0.05 ceramics occurred at 25° C. Comparisons of the 1 kHz εᵣ−T plots for z=0, z=0.025 and 0.05 are shown in FIG. 14 to highlight the development of temperature stable permittivity.

The low-field dielectric loss tangent values at 1 kHz were 0.035 from −65° C. to 320° C. (tan δ≤0.025 from −60° C. to 290° C.) for z=0.025. Losses were slightly higher in the z=0.05 sample with tan δ<0.04. Dielectric data for these 92-93% dense samples are summarised in Table 3.

TABLE 3
Summary of dielectric data of 92-93% dense Sr_{2-2z}Ca_{z}Y_{z}NaNb_{5-z}Zr_{z}O₁₅: ceramics (1 kHz data)

| Sample | | εᵣ median | ±% εᵣ | T range | | |
|---|---|---|---|---|---|---|
| Code | Intended Product Composition | (T) | T range | tanδ ≤0.035 | tanδ ≤0.03 | tanδ ≤0.025 |
| z = 0 | Sr_{2.0}Na_{1.0}Nb_{5.0}O₁₅ | 1733 | 22% −65 to | −65 to | −65 to | −32 to |
| | | (277° C.) | 300° C. | 249° C. | 238° C. | 223° C. |
| z = 0.025 | Sr_{1.95}C_{0.025}Na_{1.0}Y_{0.025}Zr_{0.025}Nb_{4.975}O₁₅ | 1565 | 13% −65 to | −65 to | −65 to | −60 to |
| | | (110° C.) | 325° C. | 320° C. | 310° C. | 290° C. |
| z = 0.05 | Sr_{1.90}Ca_{0.05}Na_{1.0}Y_{0.05}Zr_{0.05}Nb_{4.95}O₁₅ | 1310 | 10% −65 to | −40 to | −20 to | +20 to |
| | | (25° C.) | 300° C. | 370° C.* | 320° C. | 270° C. |

*for z = 0.05, tanδ increased to 0.04 between −40° C. and −65° C.

The P-E hysteresis loops for all of the compositions were generally similar in appearance and showed clear evidence of ferroelectric character (see FIG. 15a). The maximum polarisation (initially around 13 μC·cm⁻²) was reduced and the switching range around the coercive field became wider as z increased from 0 to 0.05. Significant dielectric nonlinearity and loss were evident in the sub-coercive field range (see FIG. 15b). For example, the effective tan δ value at an electric field amplitude of 4 kV·cm⁻¹ was determined as 0.154 for the undoped SNN, reducing to 0.081 and 0.060 for z=0.025 and 0.05 respectively.

Nonlinearity was also apparent in the real and imaginary parts of the complex dielectric permittivity (see FIG. 16). The observed behaviour generally departs from the classical Rayleigh Law (linear εᵣ−Eₘₐₓ relation) tending towards a quadratic response in the field range up to 15 kV·cm⁻¹. The degree of nonlinearity was strongly suppressed for z=0.05 which indicates reduced contributions to the electric field-induced polarisation from domain switching mechanisms, consistent with increasing disorder.

In summary, the primary dielectric parameters of Bi-free and Pb-free dielectric ceramics produced by very low levels of chemical substitution of a tungsten bronze Sr₂NaNb₅O₁₅ ferroelectric with Ca²⁺, Y³⁺, Zr⁴⁺ are class leading and very significant in the quest to develop base metal electrode Class II capacitor materials capable of operating over very wide temperature ranges. Future fundamental studies of crystal structure and defect chemistry will be required to elucidate the reasons why such low levels of compositional modification by Ca²⁺, Y³⁺ and Zr⁴⁺ bring about such a dramatic change in the permittivity response. However even at this early stage, it is possible to exclude core-shell microstructural mechanisms of the type which convert perovskite BaTiO₃ into a X7R temperature stable dielectric. Moreover, the concentrations of Ca²⁺, Y³⁺, Zr⁴⁺ required to flatten the permittivity response of SNN are far below those required to produce significant broadening of Curie peaks in perovskites due to compositional heterogeneity effects.

### Conclusions

A high permittivity (Class II) ceramic dielectric that offers stable permittivity to >300° C. and which does not contain problematic bismuth or lead oxides is demonstrated. Chemical substitution of Sr₂NaNb₅O₁₅ by Ca²⁺, Y³⁺ and Zr⁴⁺ ions results in a material which more than satisfies the technologically important −55° C. to 300° C. temperature range of stable capacitance required for next generation power capacitor materials. For the formulation Sr_{2-2z}Ca_{z}Y_{z}NaNb_{5-z}Zr_{z}O₁₅ where z=0.025, values of εᵣ lie in the range 1565±13% for temperatures from −65° C. to 325° C. At a higher substitution (z=0.05) the twin dielectric peaks become even more diffuse giving Er values of 1310±10% from temperatures of −65° C. to 300° C. Dielectric loss tangent values are 0.035 (1 kHz) across the full temperature range of stable permittivity for sample composition z=0.025 and tan δ is 0.025 from −60° C. to 290° C. Limiting dielectric losses were slightly higher (tan δ≤0.04) for z=0.05 samples. These primary dielectric properties are of high impact given the growing demands for next generation Class II capacitors that can operate at temperatures well beyond the limit of existing market-leading BaTiO₃ based capacitors (under 200° C.). The absence of any volatile bismuth oxide component is highly advantageous in the search for industrially-relevant dielectrics for future base metal electrode high temperature multilayer ceramic capacitors.

1. A ceramic comprising a solid solution having a tetragonal tungsten bronze structure of general formula:
Sr_{2-d}Caₑ[α]_{f}[β]_{1-g}Nb₅₋ₕ[γ]ₕO₁₅₋ₖ
wherein:
[α] denotes one or more of the group consisting of the rare earth elements and actinides;
[β] denotes one or more of the group consisting of the alkali metals and the alkaline earth metals;
[γ] denotes one or more of the group consisting of zirconium, hafnium, titanium, manganese, tin, silicon and aluminium;
−0.1≤d≤0.2;
0<e≤0.1;
0≤f≤0.2;
0≤g≤0.2;
0≤h≤0.1;
f=d+g−e;
h≤f; and
k denotes an oxygen deficit sufficient to ensure charge balance.

2. A ceramic as claimed in claim 1 which is substantially monophasic.

3. A ceramic as claimed in claim 1, wherein 0<d≤0.2.

4. A ceramic as claimed in claim 1 wherein 0.01≤e≤0.075.

5. A ceramic as claimed in claim 1 wherein 0<f≤0.2.

6. A ceramic as claimed in claim 1 wherein 0.01≤f≤0.15.

7. A ceramic as claimed in claim 1 wherein 0<h≤0.1.

8. A ceramic as claimed in claim 1 wherein 0.01≤h≤0.075.

9. A ceramic as claimed in claim 1 wherein [α] is yttrium (Y) or lanthanum (La).

10. A ceramic as claimed in claim 1 wherein [α] is yttrium (Y).

11. A ceramic as claimed in claim 1 wherein [β] is sodium (Na).

12. A ceramic as claimed in claim 1 wherein [γ] is zirconium (Zr).

13. A ceramic as claimed in claim 1 wherein the solid solution has a tetragonal tungsten bronze structure of general formula:
Sr_{2-d}CaₑY_{f}Na_{1-g}Nb₅₋ₕZrₕ O₁₅₋ₖ.

14. A ceramic as claimed in claim 1 wherein the solid solution has a tetragonal tungsten bronze structure of formula:
Sr_{2-x-y}Caₓ[α]_{y}[β]Nb_{5-y}[Y]_{y}O₁₅
wherein:
0<x≤0.1; and
0≤y≤0.1.

15. A ceramic as claimed in claim 14 wherein 0.01≤x≤0.075.

16. A ceramic as claimed in claim 14 wherein 0<y≤0.1.

17. A ceramic as claimed in claim 14 wherein 0.01≤y≤0.075.

18. A ceramic as claimed in claim 14 wherein the solid solution has a tetragonal tungsten bronze structure of formula:
Sr_{2-x-y}CaₓY_{y}NaNb_{5-y}Zr_{y}O₁₅.

19. A ceramic as claimed in claim 14 wherein x and y are the same.

20. A ceramic as claimed in claim 1 obtainable by sintering a sinterable form of a mixed metal oxide containing Sr, Ca, [α], [β], Nb and [γ].

21. Use of a ceramic as defined in claim 1 as a dielectric in a capacitor.
